(19) United States
(12) Patent Application Publication
(10) Pub. No.: US 2012/0185275 A1
(43) Pub. Date: Jul. 19, 2012

(54) SYSTEM AND METHOD OF AUTOMATED DATA ANALYSIS FOR IMPLEMENTING HEALTH RECORDS PERSONAL ASSISTANT WITH AUTOMATED CORRELATION OF MEDICAL SERVICES TO INSURANCE AND TAX BENEFITS FOR IMPROVED PERSONAL HEALTH COST MANAGEMENT

(76) Inventor: Masoud Loghmani, Crownsville, MD (US)

(21) Appl. No.: 13/351,881

(22) Filed: Jan. 17, 2012

Related U.S. Application Data
(60) Provisional application No. 61/433,212, filed on Jan. 15, 2011.

(51) Int. Cl. G06F 15/18; G06Q 50/22

(52) U.S. Cl. 705/3; 706/12

(57) ABSTRACT

Systems, methods, and computer-coded software instructions are provided for automated data analysis using graph topology techniques in a connections-mapping process to automatically identify interrelationships between various data fields in a system or body of data followed by statistical pattern analysis and machine learning techniques applied on the graphs (e.g., hidden networks) identified to improve analyses (e.g., automated analysis of medical bills and health insurance documents). Automated conversion of paper-based medical and insurance billing records to electronic data is provided, along with automatic correlation of medical services data to insurance plan policies and tax regulations for health benefits to detect errors or fraud, and to project health insurance plans for various subscribers.

This application claims the benefit of U.S. provisional application Ser. No. 61/433,212, filed Jan. 15, 2011, the entire contents of which are incorporated herein by reference.

### BACKGROUND OF THE INVENTION

1. Field of the Invention

The present invention relates generally to automated data analysis which can be useful for medical claim analysis, for example. More particularly, the present invention relates to automated data analysis using graph topology techniques in a connections mapping process to automatically identify interrelationships between various data fields in a system or body of data and in connection with statistical pattern analysis and machine learning to improve analyses (e.g., automated analysis of medical bills and health insurance documents).

2. Description of Related Art

Despite continued technological advancements in information processing and data management systems, the billing systems used to invoice subscribers and their insurers for the cost of health care services provided produce complex, confusing and often erroneous bills.

One source of error or inconsistency is due to the improper codification or classification of particular medical diagnoses and procedures in the form of standardized “Codes”. Various types of standardized coding systems have been developed as nationally accepted common formats for numerically specifying, e.g., medical conditions/diagnoses or medical services/resources. For instance, clinical data may be classified according to specific cases or medical conditions (or a group of diagnoses and conditions) using codes that follow the International Classification of Diseases (ICD) standard. Other types of standardized coding systems include, for example, CPT (current procedural terminology) codes, HCPCS (health care procedure coding system) codes, DRG (diagnosis related group) codes and APC codes.

There are various factors that can contribute to the improper classification of subscriber clinical information using standardized Codes. For instance, the coding process can be viewed as a two-step mental process that includes (i) assessing/diagnosing a medical condition/disease based on, e.g., a subscriber's symptoms and (ii) assigning a Code (e.g., ICD code) to the medical condition/disease. Accordingly, the coding process is subjective to some extent, since the codification process can be performed by a variety of people who possess different skills and expertise, which can result in different assessments of a medical condition and/or codification of such assessments. For example, different doctors (e.g., surgeon, internist) may select different ICD codes to specify a diagnosis of a particular medical condition of a subscriber based on the actual condition of a particular organ of the subscriber, or the symptomatic status of the subscriber.

Moreover, for some conditions, the coding system may not have sufficient data options to accurately reflect the condition. In addition, codes can be incorrectly input in electronic medical records of a subscriber as a result of human error. As a result, the diagnosis codes that are included in electronic subscriber medical records of a clinical database can inaccurately represent the actual medical condition of the subscribers.

The “Codes” that are included in subscriber medical records for classifying medical conditions and procedures can be used for various purposes, such as sources of information for clinical data analysis, as well as sources of data for electronic systems for insurance claims and medical billing. Therefore, it is important to properly codify medical conditions and services so that medical billings and insurance claim analyses will accurately reflect the actual medical conditions of the subscriber and medical services rendered. Indeed, inaccurate code assignments for medical conditions and services can result in inappropriate reimbursement for medical claims by insurance companies, as well as rejection or partial payment of medical claims.

Even when codes are correct, due to a myriad of complex regulations or business relationships, the invoices sent to subscribers are vague and confusing. A single operation may result in multiple bills from the surgeon, anesthesiologist, nurse, and the hospital, each carrying its own confounding codes and service descriptions, insurance discount, reimbursement amount, and final payable amount. This can get even more confusing when subscribers are covered by multiple insurers (a primary and a secondary) and need to coordinate payments to various medical service providers by their insurers.

The complexities in billing compliance have in fact risen to such a level that many small medical practices have curtailed or entirely ceased providing insurance billing, and hold the subscriber responsible for communicating with the insurance company.

These complexities also increase the cost of policing against fraud and abuse as many opportunities are present for wrongdoers to exploit loopholes in the complex billing system.

Another problem with current state of medical service billing, insurance reimbursement, and tax code is the fact that subscribers are forced to analyze complicated choices among various medical, dental, and vision insurance plans, and then decide on the amount to contribute to cafeteria health plan (or section 125 plan). Apart from the fact that the health plans and their myriad of options are extremely complicated for the average consumer, even when the consumer is well versed in analyzing the insurance choices, she does not have access to an easy to view summary of her family's past medical expenditures, nor can she reliably forecast the future needs of her family.

A need therefore exists for a system and method for automated analysis of medical service encounter information and subscriber health and related information to simplify comprehension of medical service billing, to detect fraud and/or errors in diagnoses, billing and other medical service encounter information, and to assist subscribers and users with management and use of health-related information, health insurance plan options and medical-related tax benefits, among other uses.

Further, a need exists for a system and method for automated analysis of comprehensive information to improve statistical analysis and correlation of multitudes of input and output data elements and, for example, with respect to various populations of users or other entities.

### SUMMARY OF THE INVENTION

The above and other problems are overcome, and additional advantages are realized by illustrative embodiments of the present invention.

In accordance with an aspect of illustrative embodiments of the present invention, a method of automated data analysis is provided that comprises: (a) accessing data stored in a memory device, the data comprising a plurality of records, each of the records having different data fields, each of the data fields representing a respective type of information; (b) processing the data to identify hidden networks therein by dividing the data into clusters of data and analyzing each cluster of data using an iterative connections-mapping process to identify the hidden networks wherein at least one of the data fields is assigned to represent a node and at least another one of the data fields is assigned to represent a line; and (c) analyzing the hidden networks using at least one of machine learning and pattern recognition.

In accordance with another aspect of illustrative embodiments of the present invention, terms such as “statistical analysis,” “statistical pattern recognition,” “pattern recognition,” “statistical anomaly detection” and “machine learning” refer to a body of knowledge and techniques used to analyze bodies of data using various statistical regression, machine learning, or neural network analysis methods to determine relationships between different fields of data. The automated data analysis in accordance with illustrative embodiments of the present invention does more than perform statistical pattern recognition on the data itself. That is, in addition to performing statistical pattern recognition on the data itself, the automated data analysis identifies hidden networks or hidden graphs in the data (e.g., topographic maps of relationships between various data fields in selected clusters of data stored and used in the system) as a first step, then expresses the graphs in quantitative terms, and finally performs statistical analysis on those hidden networks or hidden graphs to achieve more comprehensive information from the analyzed data as exemplified below.

Illustrative embodiments of the present invention describe the automated data analysis in connection with medical services encounter data; however, the automated analysis described herein can be applied to other types of data such as financial data and other any other body of data having two or more types of data elements or fields. The automated data analysis in accordance with illustrative embodiments of the present invention is advantageous in automating the determination of interrelationships between various data elements in a body of data for various purposes (e.g., anomaly detection, fraud detection, cost management, management of services or other resources represented by the data fields, among other uses).

In accordance with an aspect of illustrative embodiments of the present invention, a method of automated data analysis comprises: (a) accessing data stored in a memory device, the data comprising a plurality of records, each of the records having different data fields, each of the data fields representing a respective type of information; (b) selecting at least two of the data fields to each be a reference criterion; (c) dividing the data into clusters of data sharing at least one of the reference criterion; (d) iteratively analyzing each cluster of data by (d)(1) using at least a first connections mapping process wherein at least one of the data fields is assigned to represent a node and at least another one of the data fields is assigned to represent a line to generate a first topographic map of the cluster of data, and (d)(2) repeating step (d)(1) for the same cluster of data at least once by assigning a different one of the data fields to represent a node or a line to generate another topographic map of the cluster of data; (e) analyzing multiple graphs for each of the clusters of data using selected metrics to identify quantitative profiles for each graph, the graphs comprising the topographic maps generated using step (d); (f) determining which clusters are assigned a super-cluster based on similarities between at least one of the reference criterion; (g) analyzing the quantitative profiles of the graphs for each of the clusters in the super-cluster to identify similar graphs; and (h) calculating an expected graph profile for the similar graphs using data from the quantitative profiles of each of the similar graphs and statistical processing.

In accordance with another aspect of illustrative embodiments of the present invention, the automated data analysis further comprises determining the variance between at least one of the multiple graphs for each of the clusters of data and the expected graph profile.

In accordance with another aspect of illustrative embodiments of the present invention, the selected metrics are graph theory metrics comprising order, size, diameter, girth, clustering coefficient, vertex connectivity, edge connectivity, independence number, clique number, algebraic connectivity, vertex chromatic number, edge chromatic number, vertex covering number, edge covering number, isoperimetric number, arboricity, graph genus, page number, Hosoya index, Wiener index, Colin de Verdiere graph invariant, boxicity, strength, degree sequence, graph spectrum, characteristic polynomial of the adjacency matrix, chromatic polynomial, Tutte polynomial, and modularity, and community structure.

In accordance with another aspect of illustrative embodiments of the present invention, at least one of analyzing in step (e) and statistical processing in step (h) comprises at least one of statistical regression and a machine learning algorithm.

In accordance with another aspect of illustrative embodiments of the present invention, the data stored in the memory device comprises medical service encounter data for respective ones of a plurality of subscribers, the medical service encounter data comprising the plurality of data fields relating to symptoms, medical service, and subscriber-health related data, and medical service provider data, and further comprising determining the variance between at least one of the multiple graphs for each of the clusters of data and the expected graph profile to identify anomalies in the medical service encounter data. For example, at least one of analyzing in step (e) and statistical processing in step (h) comprises at least one of statistical projection and a machine learning algorithm to forecast at least one of a subscriber's health changes and medical billing changes.

### BRIEF DESCRIPTION OF THE DRAWINGS

The invention will be more readily understood with reference to the illustrative embodiments thereof illustrated in the attached drawing figures, in which:

FIG. 1 depicts steps taken by a subscriber during a sign-up process for an automated medical billing analysis system in accordance with an illustrative embodiment of the present invention;

FIG. 2 depicts steps taken after a subscriber signs-up to use an automated medical billing analysis system in accordance with an illustrative embodiment of the present invention;

FIG. 3 depicts steps taken when a letter is received at one of the processing facilities for an automated medical billing analysis system in accordance with an illustrative embodiment of the present invention;

FIG. 4 depicts computer systems and data flow processes during periodic polling of data from online sites containing data about a subscriber's medical services, insurance records, or other health information in accordance with an illustrative embodiment of the present invention;

FIG. 5 depicts computer systems and data flow processes when an online site containing data about a subscriber's medical services, insurance records, or other health information triggers a push event to start a data exchange session in accordance with an illustrative embodiment of the present invention;

FIG. 6 depicts computer systems and data flow processes when an email or other electronic message, customer service representative, phone call, or facsimile triggers data exchange with an online site containing data about a subscriber's medical services, insurance records, or other health information causing the system to create or update data about a subscriber's medical or insurance services in accordance with an illustrative embodiment of the present invention;

FIG. 7 depicts data flow processes with respect to newly received or updated data about a subscriber's medical or insurance services in accordance with an illustrative embodiment of the present invention;

FIG. 8 depicts data flow processes for conducting anomaly detection analysis after medical or health services records are created or updated for a subscriber to detect fraud in accordance with an illustrative embodiment of the present invention;

FIG. 9 depicts data flow processes for performing periodic analysis of a subscriber's health services in accordance with an illustrative embodiment of the present invention;

FIG. 10 depicts computer systems and data flow processes for periodic polling of data from online sites to update rules, regulation, and policy information about various insurance plans, health benefit packages, or tax regulations in effect, as well as facilities for manually updating the same rules, regulation, and policy information, in accordance with an illustrative embodiment of the present invention;

FIG. 11 depicts a multitude of service encounter records as input data for different patients, and the accompanying relationships between the input data and the actual results for diagnosis, medication, and lab-tests wherein the relationship between input data and the actual results is a formula defining an expected profile for diagnosis, treatment, and lab-tests and the formula is derived using parametric or semi-parametric regression techniques in accordance with an illustrative embodiment of the present invention;

FIG. 12 depicts data flow processes for determining whether a detected anomaly is probable in accordance with an illustrative embodiment of the present invention;

FIG. 13 depicts data flow processes for anomaly detection wherein, for inter-related subscriber records having common data in a data field, variance is determined between statistical distribution of other data points and the same distribution for a comparison population in accordance with an illustrative embodiment of the present invention;

FIGS. 14A and 14B depict, respectively, a sample of a data cluster for a given zip-code and profile of subscribers, and a graph based on some of the data in the sample data cluster, in accordance with an illustrative embodiment of the present invention;

FIGS. 15A and 15B depict, respectively, samples of data clusters for given zip-codes and profile of subscribers, and a graph based on some of the data in the sample data cluster in accordance with an illustrative embodiment of the present invention;

FIGS. 16A and 16B each depict quantitative data for various graphs for a given cluster of data, and FIG. 16C depicts distribution of the quantifiers for a specific type of graph in a super cluster, in accordance with an illustrative embodiment of the present invention;

FIG. 17 depicts a visual representation of the statistical distribution of quantitative data for similar graphs in a super cluster of data in accordance with an illustrative embodiment of the present invention;

FIG. 18 depicts an online user-interface for users to view multiple service encounters, and the relevant data about each service encounter, in accordance with an illustrative embodiment of the present invention;

FIG. 19 depicts computer systems and data flow for subscribers or users to use a computing device (e.g. a mobile personal digital assistant) to generate requests about a subscriber's health service information via electronic messaging through the Internet or private network, to process the message (e.g., via a message parsing server), and to forward the processed message to a main server through the Internet or private network, in accordance with an illustrative embodiment of the present invention;

FIGS. 20A and 20B depict, respectively, an application residing on a subscriber's or user's computing device that provides an interface with which to access an automated medical billing analysis system in accordance with an illustrative embodiment of the present invention; and

FIGS. 21A and 21B depict, respectively, an application residing on a subscriber's or user's computing device that provides one or more “follow-on” pages of the application to access specific services of an automated medical billing analysis system in accordance with an illustrative embodiment of the present invention.

Throughout the drawing figures, like reference numbers will be understood to refer to like elements, features and structures.

### DETAILED DESCRIPTION OF ILLUSTRATIVE EMBODIMENTS

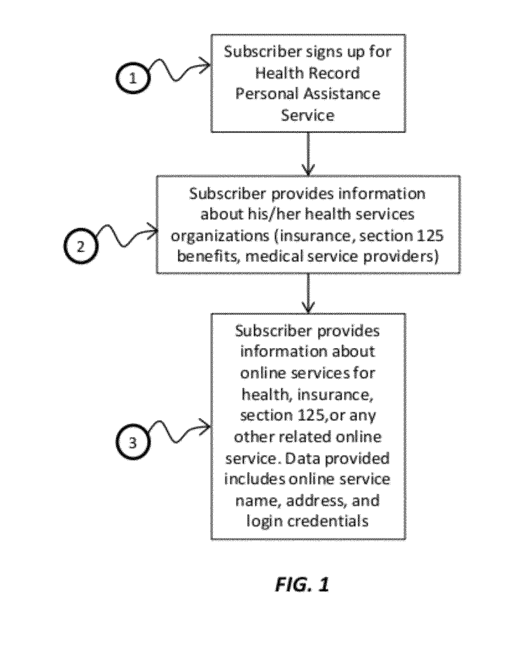

In accordance with illustrative embodiments of the present invention and with reference to FIGS. 1-21, a method and system are provided to assist subscribers in automating the organization and analysis of medical service encounter data provided in their medical invoices and insurance invoices and related documents and letters. Health insurance subscribers receive large amounts of information from medical service providers, health insurance companies, employers, or health benefits service providers, collectively referred to as health services organizations hereinafter, on a regular basis. Very often a single operation may result in multiple invoices and insurance letters being sent to the subscriber, causing confusion and increasing error likelihood. In accordance with an embodiment of the present invention, improved automated data analysis is provided to process the medical service encounter data. In the context of the present disclosure the terms “statistical analysis”, “statistical pattern recognition”, “statistical anomaly detection”, and “machine learning” are all intended to refer to the body of knowledge and techniques used to analyze bodies of data using various statistical regression, machine learning, or neural network analysis methods to determine relationships between different fields of data. The improved automated data analysis does more than perform statistical pattern recognition on the data itself. That is, in addition to performing statistical pattern recognition on the data itself, the improved automated data analysis identifies hidden networks or hidden graphs in the data (e.g., topographic maps of relationships between various data fields in selected clusters of data stored and used in the system) as a first step, then expresses the graphs in quantitative terms, and finally performs statistical analysis on those hidden networks or hidden graphs to achieve more comprehensive information from the analyzed data as exemplified below.

The improved automated data analysis is described herein in connection with medical services encounter data in accordance with illustrative embodiments of the present invention. It is to be understood, however, that the improved automated analysis described herein can be applied to other types of data such as financial data and other any other body of data having two or more types of data elements or fields. The automated data analysis in accordance with illustrative embodiments of the present invention is advantageous in automating the determination of interrelationships between various data elements in a body of data for various purposes (e.g., anomaly detection, fraud detection, cost management, management of services or other resources represented by the data fields, among other uses).

In an illustrative embodiment of the present invention and with reference to FIG. 1, the automated medical billing analysis system allows patients or subscribers to sign-up (1) for the services provided by this system and, while doing so, identify (2) their health insurance service providers, as well as provide (3) information about online services for health, insurance, section 125, or any other related online service. Data provided in this step includes online service name, online address, and login credentials. The system stores all data provided during sign-up for subsequent processing of various messages and requests by the subscriber or about subscriber's health services. As an example, using this log-in credential, the system exemplifying the present invention is able to log-in on behalf of the user to various online sites belonging to health services organizations involved in delivering health services to the subscriber, and gather information such as services rendered, insurance reimbursement provided, or tax benefits paid to the subscriber.

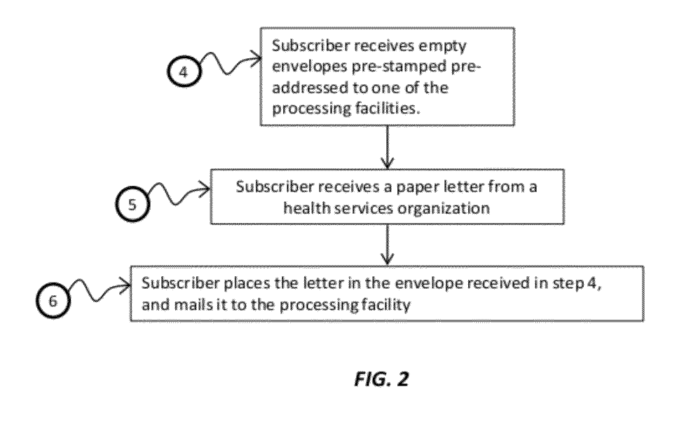

Referring to FIG. 2, in accordance with an illustrative embodiment of the present invention, the system can provide (4) each subscriber on a regular basis with empty pre-stamped and pre-addressed envelopes. Still referring to FIG. 2, when subscribers receive (5) new letters from one of their health services organizations, they place (6) the letter in the pre-stamped pre-addressed envelope and mail it to the processing facility.

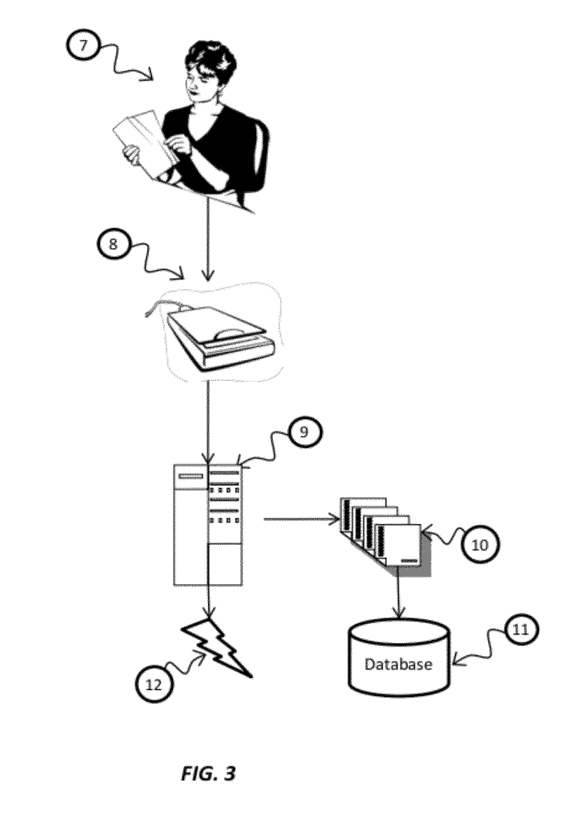

Referring to FIG. 3, letters received at the processing facility are sorted (7), scanned (8) and sent to a main server (9) where using optical character recognition and intelligent form-processing (9) the scanned image is converted to electronic records (10) that are stored in the subscriber records databases (11) for later retrieval. Alternatively, each subscriber or user can input electronic information to the main server (9) for processing and storage in the databases (11).

For example, the system provides a user-interface for subscribers or other users of the system. The user-interface may be electronic, organic, or otherwise. Through this user interface, a subscriber or user can enter information about their health condition, as well as details of a given medical service-encounter. The details can include data such as symptoms before the service encounter, at the time of the encounter, after the encounter, diagnosis offered by the service provider, type of services rendered, medication prescribed and taken, assistive or diagnostic technologies or tools used, duration of the service encounter, and names of service providers encountered. Through this user interface subscriber or user may also access medical invoices, medical information and insurance information, among other types of information, through an online portal or mobile application. For example, a subscriber can access the online portal for easy access to various invoices and insurance statements related to a given procedure or service that have been organized by the system in accordance with illustrative embodiments of the preset invention.

In accordance with another embodiment of the present invention, the system can perform medical insurance error and anomaly detection described further below to track the billings by each medical service provider across all subscribers in the systems' database over time and flag abnormal or suspicious patterns.

In another aspect, the system is equipped with electronic interfaces for direct data exchange with medical service providers, insurance companies, or third party medical data warehousing service providers.

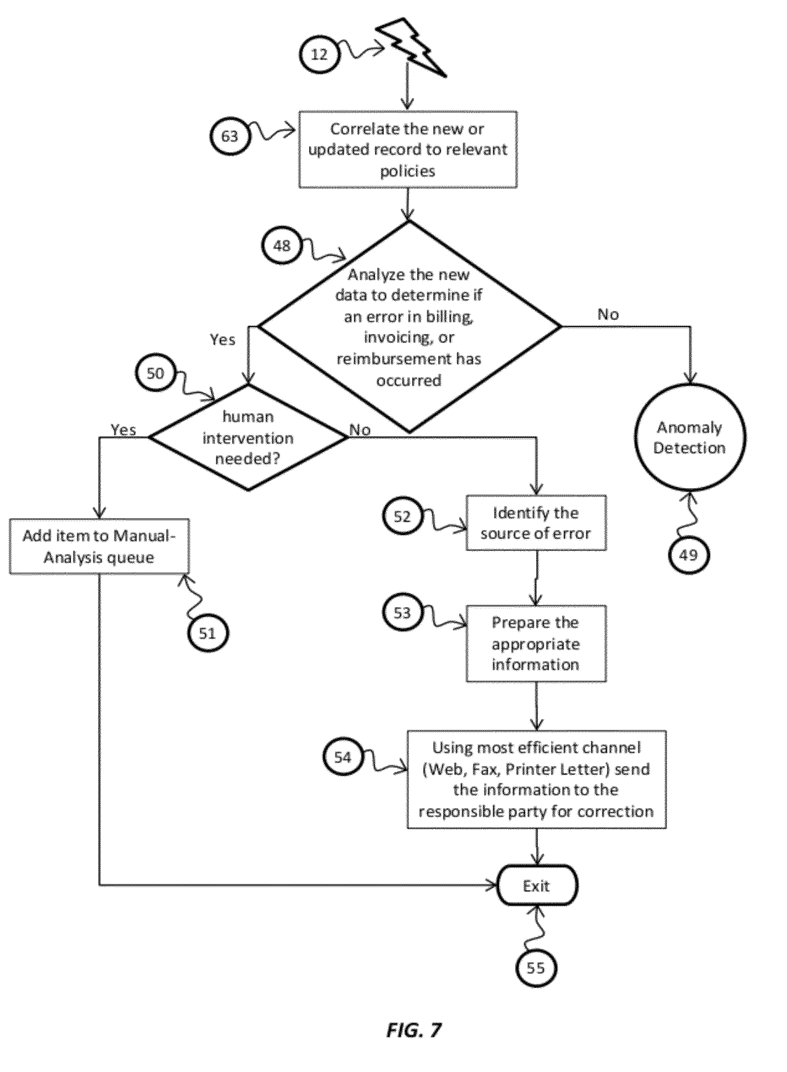

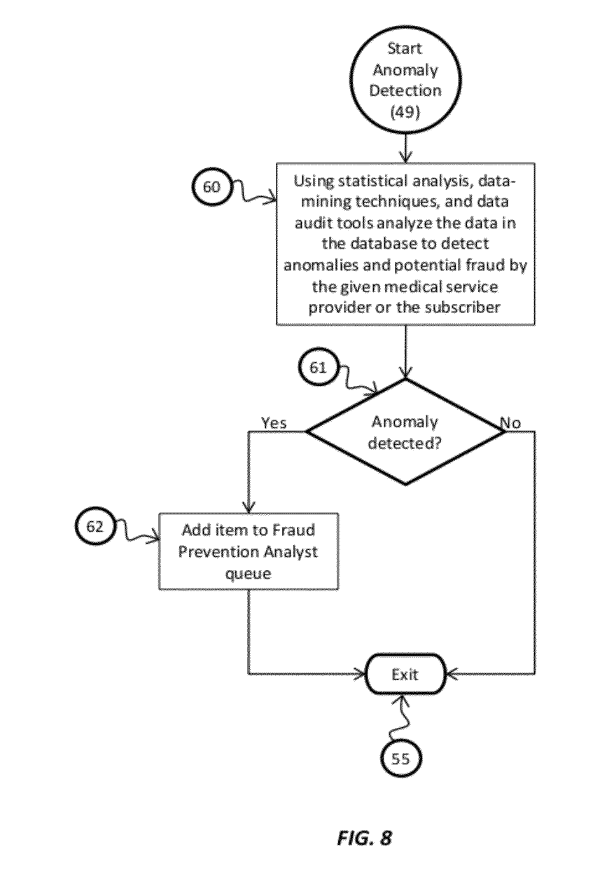

Referring still to FIG. 3, each time an electronic record is created or updated, a trigger (12) is raised that causes specialized algorithms such as algorithms for error detection (shown in FIG. 7) and anomaly detection (shown in FIG. 8) to be executed. The algorithms can be executed, for example, by the main server (9).

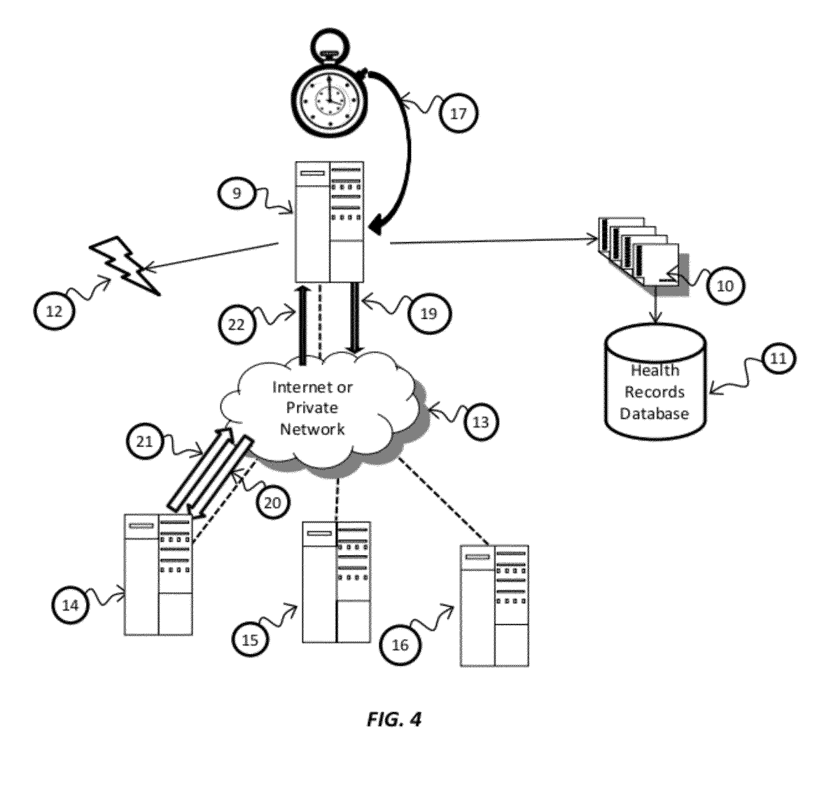

In another embodiment of the present invention, shown in FIG. 4, a periodic process (17) issues a command to the main process server (9) forcing it to launch a “poll” process for retrieving health services information from one of the many potential online servers belonging to health services organizations hosting data about various subscribers. Examples of such online servers can include, but are not limited to, insurance servers (14), health benefits servers (15), or medical service provider servers (16). For the purposes of this system, “server” refers to any combination of software that provides the logical steps provided. Physical embodiments of “servers” vary greatly as technology evolves and physical location of the hardware, or its method of control, have no bearing on the operation of this system.

Upon initiation of the poll process, the main server (9) sends an electronic request (19) through the Internet or other type of network (private or dedicated link) (13) to a health service organization's data server (14). The request may initially use the login credentials of the subscriber which were supplied earlier (3) to gain access to the health organization's data server on behalf of the subscriber. Once access is granted, subsequent requests (19) are generated. For each request (19) sent through the Internet or other type of network (13), a corresponding request (20) is received by the health organization's data server (14). The health organization's data server (14) processes each request (20) received and generates a response (21), and sends the response back through the Internet or other type of network (13). For each response (21) sent through the Internet or other type of network (13), a corresponding response (22) is sent to the main server (9). On the main server (9) side, the response (22) is received and processed. If further data exchange is needed, the process described above and depicted in FIG. 4 may be repeated (e.g., elements 9, 19, 13, 20, 14, 21, 13, 22, and 9 in FIG. 4 are repeated).

Throughout the data exchange process, the main server (9) analyzes the content received from the health service organization's data server (14), and creates or updates electronic records (10) that are stored in the subscriber records databases (11) for later retrieval. Data received from the health service organization may include a multitude of records, each record with a multitude of data fields. Each record may contain information about different services provided for the subscriber or products used during the course of a medical service encounter. Each data field may contain information such as date, subscriber's name, age, sex, weight, race, temperature and blood pressure at the time of service, the name of health-care service provider (or entity) delivering the service, symptoms, diagnoses, treatment, medication, amount charged, amount discounted, amount paid by the patient, primary/secondary/tertiary insurance companies billed, subscriber's guardian's name, or any other medical, legal, or financial information relevant to the service provided.

Referring still to FIG. 4, each time an electronic record is created or updated, a trigger (12) is raised that causes algorithms for error detection (shown in FIG. 7) and anomaly detection (shown in FIG. 8) to be launched (e.g., at the server (9)). These algorithms, further discussed below, can use the interaction depicted in FIG. 4 to fill out or otherwise populate online forms on behalf of the user or initiate other actions to request refunds, correct errors, submit additional information, request follow-up by the service provider representative, or any other service or function permitted to a general user accessing the same website.

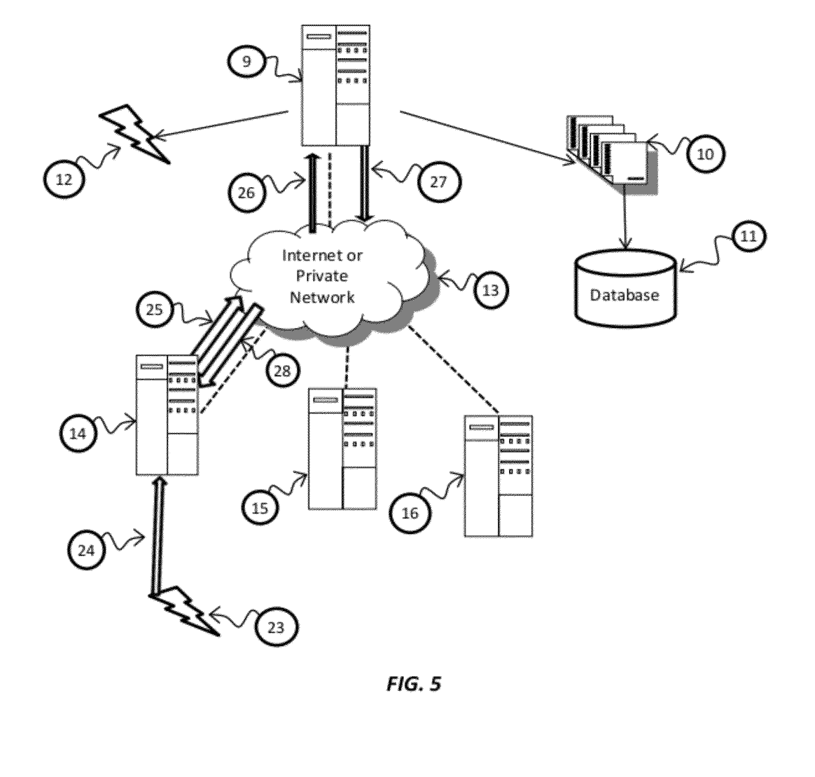

In another embodiment of the present invention, shown in FIG. 5, the system receives updates or handles requests about a subscriber's health service information directly from the subscriber's health services organizations with no need for paper processing. In this embodiment, an external trigger (23) such as a visit to a medical service provider, or a request for reimbursement sent to an insurance company, may launch a push process at one of subscriber's health services organizations. This trigger (23) will cause one of the data servers (14) at the health services organization to generate an electronic push request (25) through the Internet or other type of network (private or dedicated link) (13). For each push request (25) sent through the Internet or other type of network (13) a corresponding response (28) is received by the health organization's data server (14). The push request on the main server side (26) is processed by the main server (9), and a response or request for more details (27) is sent through the Internet or other type of network (e.g., a private or dedicated link) (13) to the health service organization's data server (14). If further data exchange is needed, the process described above and depicted in FIG. 5 may be repeated (e.g., repeat elements 14, 25, 13, 26, 9, 27, 13, 28, and 14 in FIG. 5). With regard to the exchanged data format, available standards for data communication can be implemented to ensure compatibility and consistent comprehension of data among different entities. For medical electronic billing, for example, the above-described and other standard information can be shared among the various users or medical billing stakeholders using, for example, an internet-based or other “backend” system to facilitate the downloading of data from one user's system to another user's system. Throughout the data exchange process, the main server (9) analyzes the content received from the health service organization's data server (14), and creates or updates electronic records (10) that are stored in the subscriber records databases (11) for later retrieval.

Referring still to FIG. 5, each time an electronic record is created or updated, a trigger (12) can be raised that causes algorithms for error detection (shown in FIG. 7) and anomaly detection (shown in FIG. 8) to be launched. These algorithms, further discussed below, can use the interaction depicted in FIG. 5 to fill out or otherwise populate online forms on behalf of the user or initiate other actions to request refunds, correct errors, submit additional information, request follow-up by the service provider representative, or any other service or function permitted to a general user accessing the same website.

In accordance with another embodiment of the present invention, subscribers send their paper-based invoices to a processing facility where all paper-based records (e.g., medical service encounter documents) are scanned and converted to electronic data. Alternatively, subscribers send electronic medical encounter-related data to the main server (9). In another aspect, the automated medical billing analysis system extracts medical and insurance information from the converted documents or electronic data and stores the extracted data in databases (11) designed to maintain the information.

In another aspect, the system uses Internet protocols to connect to the websites that contain information about a subscriber's insurance records, medical services, section 125 plan benefits, or any other general data that may be relevant and then, using the subscriber's login credentials, logs onto the website and retrieves the information about the user's medical services as well as insurance records and stores the retrieved information.

In another aspect, the system, after logging on to websites that contain various health and finance related information such as a subscriber's insurance records, medical services received, section 125 plan benefits, or any other general data that may be relevant, can fill out online forms on behalf of the user or initiate other actions to request refund, correct errors, submit additional information, request follow-up by the service provider representative, or any other service or function permitted to a general user accessing the same website.

In another aspect, the system uses telephone lines or other modes of communication (e.g., wire-line and/or wireless links and one or more communications protocols) to contact subscribers, medical service providers, insurance companies, or other professionals or service providers (such as legal counselors) and uses the proper mode of signaling and two-way communication (such as text messages, email, Dual Tone Multi-Frequency (DTMF) signals, Text To Speech, pre-recorded audio messages, and Speech Recognition) to exchange information about a subscriber's medical services, insurance services, section 125 plan, or any other topic that may be relevant.

In another aspect, the system continually updates a database (11) of insurance rules, regulations, and policies for various insurance plans provided by different insurance companies, as well as tax regulations in force for health and medical pre-tax benefits such as section 125 plan.

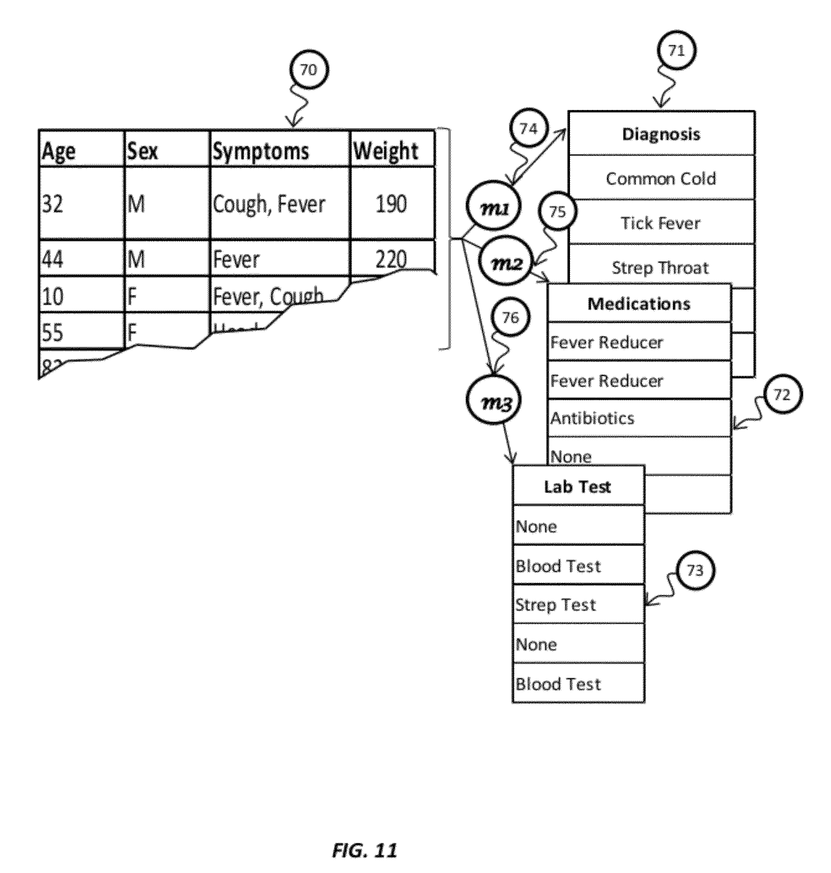

In another aspect, the system correlates medical services rendered to a subscriber's insurance coverage plan to determine, for example, eligibility for benefits under the plan such as reimbursement for expenses for the services. In another aspect, the system uses a database of various insurance rules and regulations, as well as medical codes, to detect errors in billing or reimbursements by medical service providers or insurance companies, respectively. Examples of methods for such analyses are described below in connection with FIGS. 11-17.

In another aspect, the system stores various data elements in a given subscriber's medical billing records in the database (11). The data elements stored can include, but are not limited to, subscriber's gender, age, profession, medical history (subscriber and relatives if available), date of service, season, location, symptoms, the diagnosis, the services provided, the products used in the course of service delivery, the medication or course of treatment, the names of service providers, lab tests scheduled and performed, any lab results if available, and various billing related data.

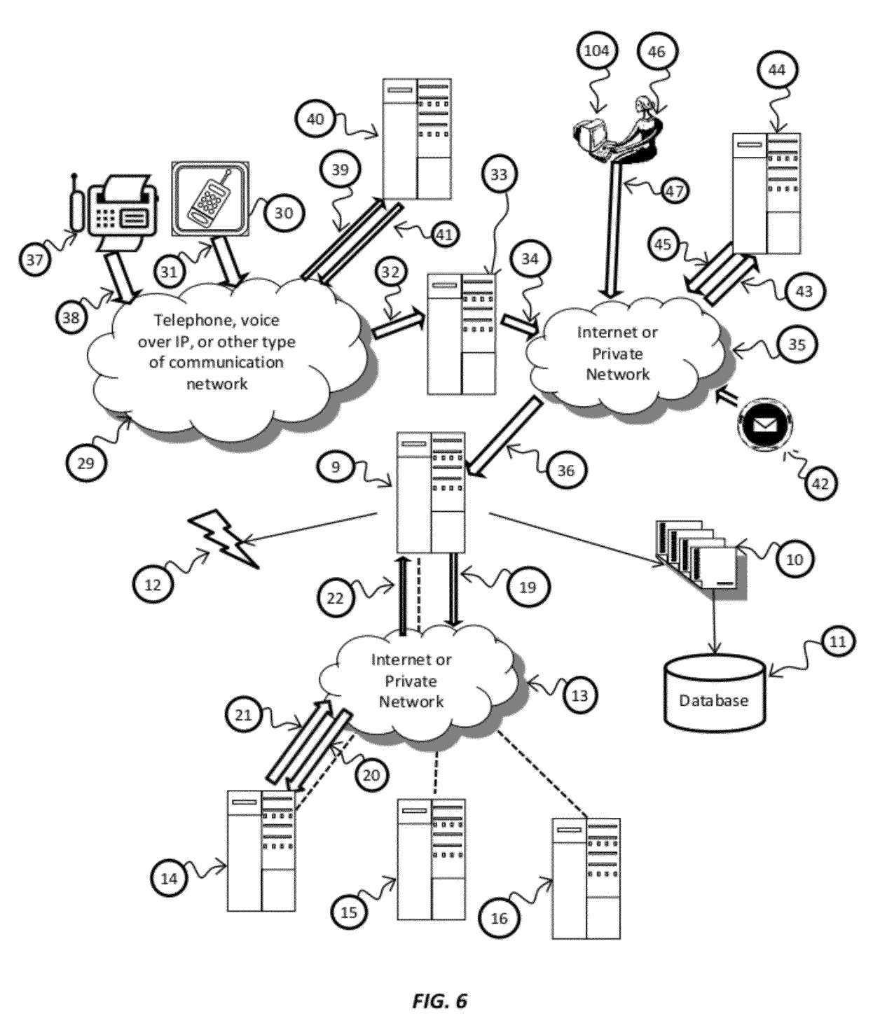

In another embodiment of the present invention, shown in FIG. 6, the system receives updates or handles requests about a subscriber's health service information via email or other electronic messaging (42) through the Internet or private network (35) sent to message parsing server (44), and from there, the processed message (45) is forwarded to the main server (9) through the Internet or private network (35).

Still referring to FIG. 6, in another embodiment of the present invention, the system receives updates or handles requests about a subscriber's health service information via messages generated by human users (e.g., the subscriber or a customer service representative) (46) using a communication interface device (104) which may be electronic (e.g., desktop computer, laptop computer, tablet, or mobile device), or semi-electronic and semi-organic (e.g., Nano-robot embedded in users body) or fully-organic, the interface device sending and receiving users messages and update via the Internet or private network (35) to message parsing server (44), and from there, the processed message (45) is forwarded to the main server (9) through the Internet or private network (35).

Still referring to FIG. 6, in another embodiment of the present invention, the system receives updates or handles requests about a subscriber's health service information via computing devices (40) such as servers, personal computers, laptop computers, tablet computing devices, personal digital assistants interacting through the Telephone, Voice over IP, or other type of communication Network (29) with voice and facsimile messaging server (33).

Still referring to FIG. 6, in another embodiment of the present invention, the system receives updates or handles requests about a subscriber's health service information via telephone interface systems (30) or facsimile machines (37) interacting through the Telephone, Voice over IP, or other type of communication Network (29) with voice and facsimile messaging server (33). In an embodiment of the present invention, in order to extract the data that should be used to update a subscriber's record, the Voice and facsimile messaging server (33) uses pre-determined dialog-flows (e.g., question and answers used in the case of voice communication with standard speech recognition techniques commonly used by Interactive Voice Response systems) or pre-determined form-structures that can be converted to electronic data using standard Optical Character Recognition tools. In another embodiment of the present invention, the Voice and facsimile messaging server (33) uses a combination of speech-recognition and natural language intent-understanding (e.g., using standard third party tools) to interact with voice callers in a conversational manner when collecting the updates. In either embodiment, the system processes received requests and updates (32) and, after processing, sends the processed message (34) to the main server (9) through the Internet or private network (35). Upon receipt of updates or requests, still referring to FIG. 6, the main server (9) analyzes the content received in the message (36), and creates or updates electronic records (10) that are stored in the subscriber records databases (11) for later retrieval.

Throughout the data exchange process, the main server (9) analyzes the content received from the health service organization's data server (14), and creates or updates existing electronic records (10) that are stored in the subscriber records databases (11) for later retrieval.

Referring still to FIG. 6, each time an electronic record is created or updated a trigger (12) can be raised that causes algorithms for error detection (shown in FIG. 7) and anomaly detection (shown in FIG. 8) to be launched via the server (9). These algorithms, further discussed below, can use the interaction depicted in FIG. 6 to fill out or otherwise populate online forms on behalf of the user or initiate other actions to request refunds, correct errors, submit additional information, request follow-up by the service provider representative, or any other service or function permitted to a general user accessing the same website.

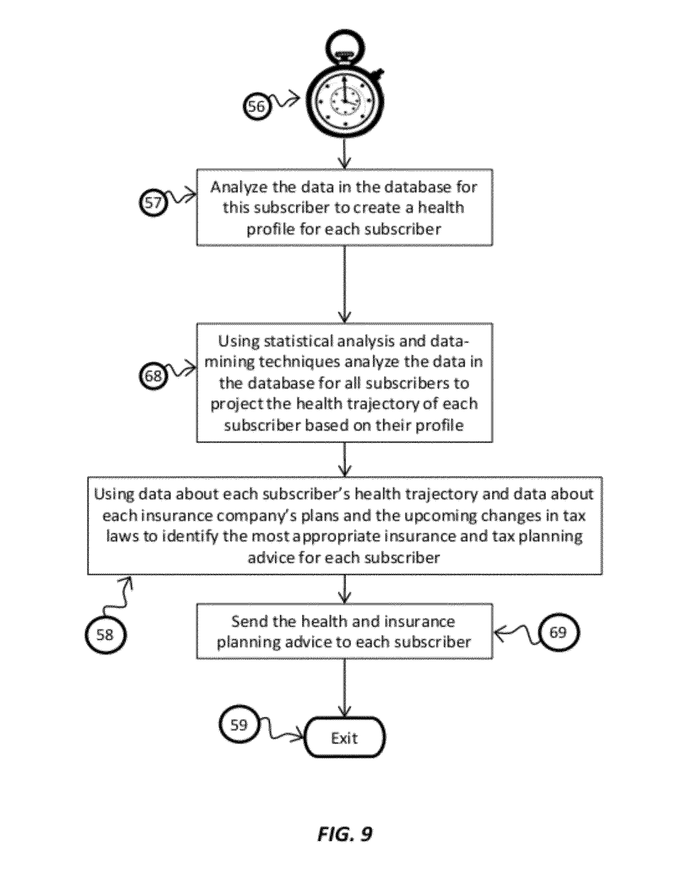

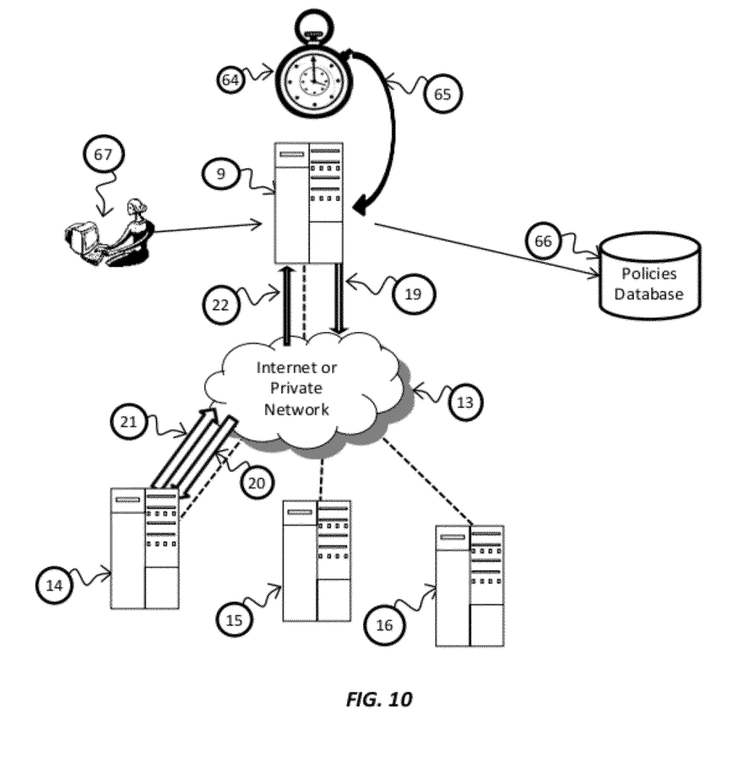

After logging on to websites that contain information about a subscriber's insurance records, medical services, section 125 plan benefits, or any other general data that may be relevant, and after creating or updating records (10) for the subscriber in the subscriber records database (11), the system generates a trigger (12) that executes the error and anomaly detection algorithm, referring to FIG. 7. The first step (63) in this algorithm interprets, converts, and correlates the new or updated records to the medical, health, or tax rules and policies applicable to the given subscriber (e.g., via statistical regression as exemplified below in connection with FIGS. 9-11). These rules and policies are stored in the policies database (66) shown in FIG. 10.

In the next step, the algorithm illustrated in FIG. 7 analyzes the new or updated records (10) to determine if any error in billing (e.g., such as erroneous coding of procedures, improper or non-billing of secondary insurance, or other errors), invoicing, or reimbursement has occurred given the rules, regulations, and coverage policies applicable to the given subscriber. If any errors are detected, the error is analyzed to determine whether human intervention is required to handle it (50). If so, a ticket is created, and the error is added to a special queue for manual analysis (51). On the other hand, if automatic error handing can be achieved, the algorithm identifies (52) the source of the error, prepares the appropriate information that can assist the responsible party in addressing the error (53), and finally submits the error correction request using the most appropriate channel to the responsible party (54), before exiting (55). One illustrative embodiment of this error report is accessing a medical service provider's online site, navigating to a billing inquiries section, and then submitting an online form containing subscriber identification information, the service in question, description of the error, and a request for correction. Another illustrative embodiment of this error report is preparing a detailed facsimile containing subscriber identification information, the service in question, description of the error, and a request for correction, and then sending the facsimile to the medical service provider, or their billing representative, responsible for correcting the error.

Still referring to FIG. 7, in another aspect of the present invention, if the algorithm does not detect any error in step (48), it moves on to the starting point (49) for another algorithm for anomaly detection (shown in FIG. 8).

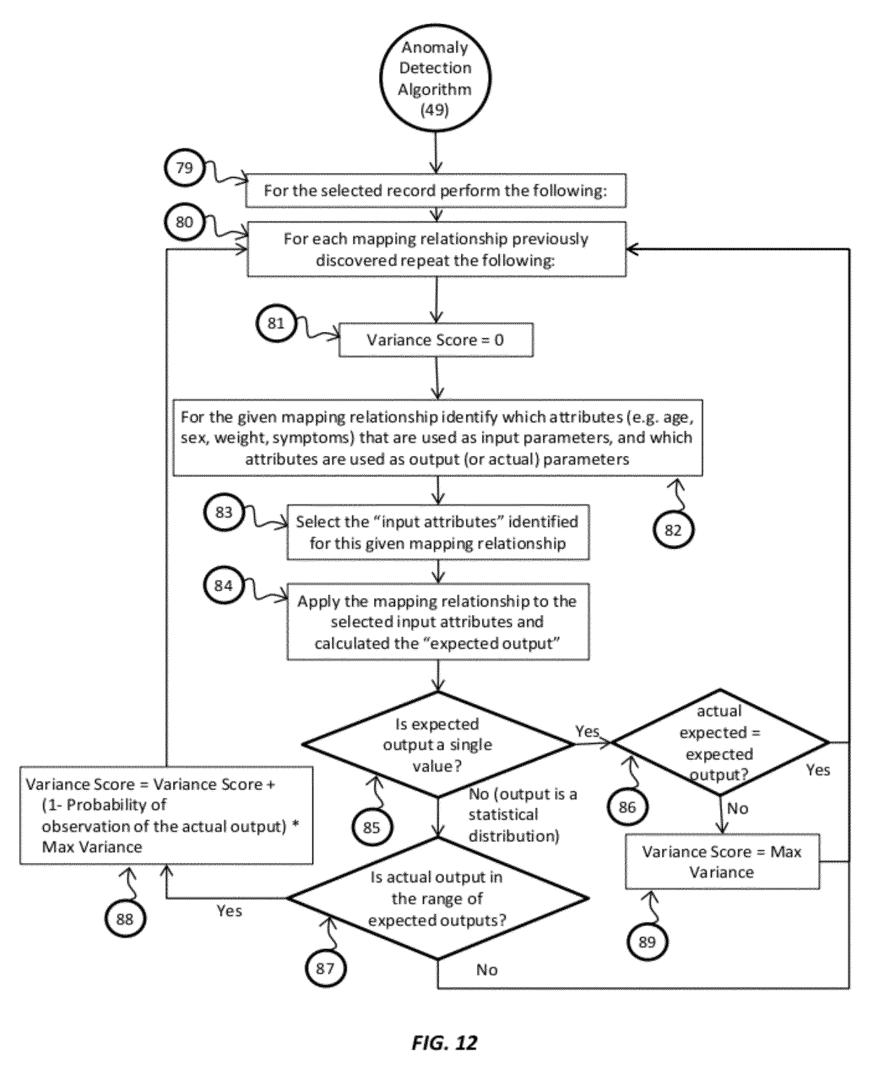

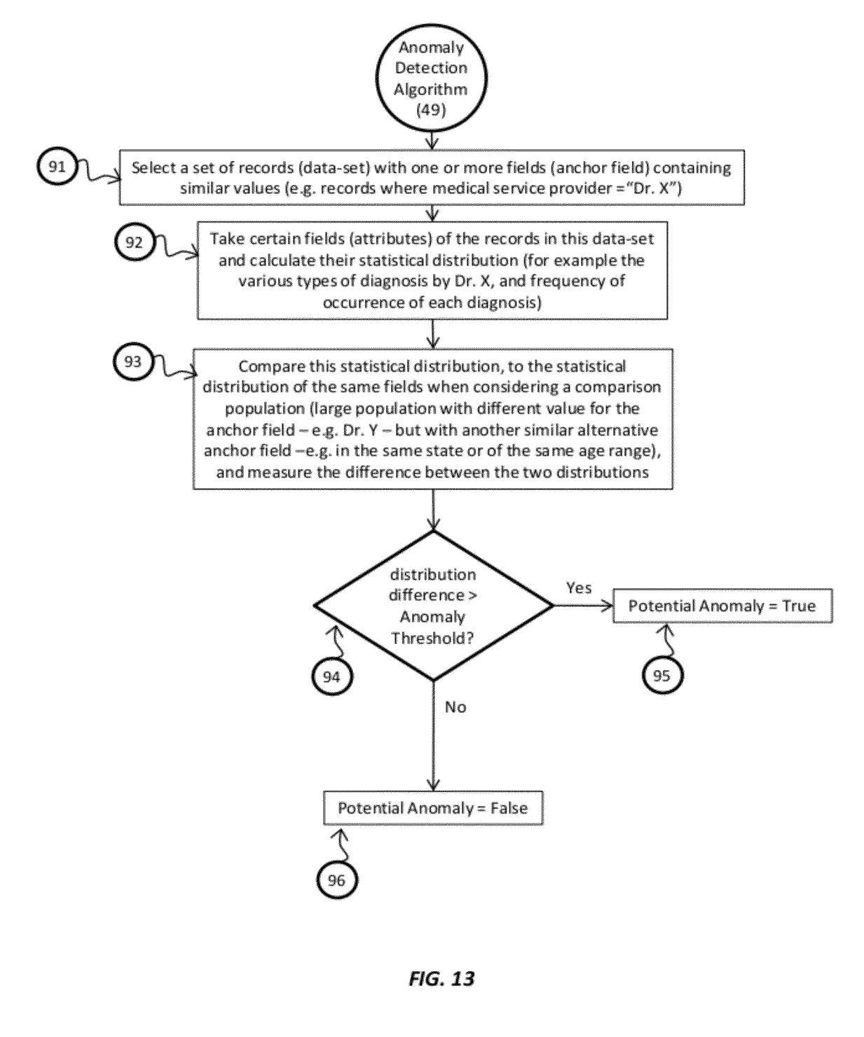

In accordance with another illustrative embodiment of the present invention, shown in FIG. 8, the system uses an anomaly detection algorithm (49) that is executed after an error detection algorithm, shown in FIG. 7, detects no billing error. The error detection algorithm is executed, for example, after a record is created or updated in the subscriber records database(s) (11). In the first step (60) of the anomaly detection algorithm illustrated in FIG. 8, the present invention uses statistical analysis, data-mining techniques, and a data audit algorithm (further described below in connection with FIG. 12 and FIG. 13) to analyze the data in the subscriber records database (11) and detect anomalies and potential fraud by the given medical service provider or the subscriber. In this process, the algorithm scans the entire database in multiple sweeps to detect different forms of medical fraud. As an example, in one sweep, the system scans the entire database for all services provided by the given medical service provider for all subscribers. In another sweep, the system scans the subscriber's record to detect fraud in the name of the given subscriber, which may occur as a result of identity theft. If, in any of the sweeps conducted in the first step (60) an anomaly is detected, then the item is added to a queue for analysis by fraud prevention analysts; otherwise, the algorithm (49) is terminated as indicated at (55).

In another aspect, shown in FIG. 9, the system uses a periodic process (56) to track a subscriber's health over the course of time and, using statistical analysis and projections based on data from other subscriber's in the same age and health category, helps each subscriber make adjustments to his/her health, dental, or medical insurance, as well as section 125 plan, to obtain optimum coverage with least out of pocket expenses. In the first step of this process (57), the algorithm analyzes the data in the database, and creates a health profile for each subscriber. In the next step (68), the algorithm uses statistical analysis and data-mining techniques to analyze the data in the database for all subscribers and optionally other data (e.g., externally collected data that is not necessarily related to the subscribers but rather related to a more general patient population) to project the health trajectory of each subscriber based on their profile. In the next step (58), the algorithm uses data about each subscriber's health trajectory and correlates that data to each insurance company's plans, as well as the upcoming changes in tax laws, to identify the most appropriate insurance and tax planning advice for each subscriber. In the next step (69), the system contacts each subscriber to provide them the advice before exiting the periodic process (56) as illustrated at (59).

In another aspect of the present invention, shown in FIG. 10, a periodic process (64) issues a command (65) to the main process server (9) forcing it to launch a “poll” process for retrieving the latest health service policies and regulations for different health or medical insurance plans offered by various insurance companies or health benefit related information such as pre-tax health benefit plans such as section 125 plan. Examples of online sites polled can include, but are not limited to, insurance sites (14), health benefits sites (15), medical service provider sites (16), as well as Internal Revenue Service site or the subscriber's employer site. Upon initiation of the poll process, the main server (9) sends an electronic request (19) through the Internet or other type of network (private or dedicated link) (13) to a health service organization's data server (14). The request may initially use the login credentials of the subscriber which were supplied earlier (3) to gain access to the health organization's data server on behalf of the subscriber. Once access is granted, subsequent requests (19) are generated. For each request (19) sent through the Internet or other type of network (13), a corresponding request (20) is received by the health organization's data server (14). The health organization's data server (14) processes each request (20) received and generates a response (21), and sends it back through the Internet or other type of network (13). For each response (21) sent through the Internet or other type of network (13), a corresponding response (22) is sent to the main server (9). On the main server (9) side, the response (22) is received and processed. If further data exchange is needed, the process described above and depicted in FIG. 4 may be repeated (e.g., repeated cycling through elements 9, 19, 13, 20, 14, 21, 13, 22, and 9 in FIG. 4).

Referring still to FIG. 10, throughout the data exchange process, the main server (9) analyzes the content received from the health service organization's data server (14), and automatically creates or updates electronic health policy or plan rules that are stored in the policies databases (66) for later retrieval. In another aspect, the present system provides a human user interface where benefit analysts (67) can review, update, or correct health policy or plan rules stored in the policies database (66).

In accordance with an embodiment of the present invention, the system can automatically analyze data stored across all subscribers in the database using statistical pattern recognition techniques to create a family of “expected profiles” for each given input data point with each “expected profile” providing information along a given dimension. For example, for a “diagnosis” data-point, the dimensions for which an “expected profile” will be created can include: expected symptoms profile, expected tests profile, expected treatment (type/duration) profile, expected expertise involved profile, expected complications profile, expected other sicknesses profile, expected follow-up profile, and expected cost profile. As an example, the system analyzes all billing records for patients who have had a diagnosis for common-cold, and determines that the expected treatment may include fever-reducing medication, but not eye-surgery. In this example, the expected treatment profile may be expressed by a formula such as:

Expected Treatment=relationship map m1 (diagnosis)

Expected Symptom=relationship map m2 (diagnosis)

Expected Follow-up=relationship map m3 (diagnosis)

In another aspect, the system uses statistical regression to analyze data across all subscribers in the database to create formulae that show the relationships between a number of input data-points and various “expected profiles”. The regression methods include, for example, parametric regression where specific features of the input data are known to correlate to the output data, but where the specific relationship is unknown, as well as semi-parametric regression and non-parametric methods. As an example, a subscriber's age, gender, and specific prior ailments are input data that may be regressed against available data for course of treatment to generate a formula which determines the expected course of treatment profile when symptoms, diagnosis, age, gender, weight, prior ailments, and season are known. In this example the expected treatment profile may be expressed by a formula such as:

Expected Treatment=relationship map m4(svmptoms, diagnosis, age, gender, weight, prior ailments, season)

The database will also be populated with data for diagnoses from medical sources that are not necessarily associated with any of the subscribers whose data is added to the database (e.g., Sloan-Kettering Cancer Center data or the T1D Exchange Clinical Registry). In another aspect, the system assigns a confidence score to the forecasts that each formula may provide based on how closely the input data can predict the output data for each formula in the system. As an example, for a relationship map m4 predicting expected treatment based on symptoms, diagnosis, age, gender, weight, prior ailments, and season, the confidence score may be a function of the variance between predicted values and actual values observed in the sample population.

Expected Treatment=relationship map m4(symptoms, diagnosis, age, gender, weight, prior ailments, season)

relationship map m4 confidence score=s(variance between predicted values and actual values)

In another aspect, the system uses non-parametric and semi-parametric regression methods that allow the system to take into account variations between groups of input data that may result in the same output with limited or no prior known relationship between input data and output data. As an example, the same medical procedure or series of medical procedures may be appropriate for patients with varying statistical profiles. In this case, the system identifies clusters of input data for each given potential output using semi-parametric density estimation generating a probability profile for different clusters of input data.

FIG. 11 illustrates an embodiment of the present invention wherein the system uses statistical regression techniques such as parametric and semi-parametric regression to discover relationships between the data obtained from and about subscribers (as well as publically available data such as Sloan-Kettering Cancer Center data or the T1D Exchange Clinical Registry). In discovering these relationships, various combinations of input and output data fields are passed through multiple regression engines implemented, for example, at the main server (9). Still referring to FIG. 11, one such set of input and output data is depicted. For example, for each record, a group of four data fields (70) comprising Age, Sex, Symptoms, and Weight, are considered as input data. Three independent rounds of regression analysis data fields (i.e., Diagnosis (71), Medications (72), and Lab-Test (73)) are considered as output fields, for example. In each case, the system runs through various regression models to determine whether there is any parametric or semi-parametric relationship between the group of input data and each output data. As an example, the system may detect that the set of input data (70) may be interrelated to Diagnosis (71) through a map m1 (74). Examples of expressions for mapping relationships are further described below. In this scenario, map m1 (74) may take the form of a linear or polynomial parametric function, or a semi-parametric function comprised of multiple parametric sub-functions (e.g., each function depending on one more input data elements), or a relationship between various sets of input data and various distributions of possible output values. The system can also assign a confidence score to map m1 (74) which describes how closely this map can predict the Diagnosis (71) based on the input data provided (70). If map m1 (74) describes a relationship between various sets of input data and various sets of distributions of possible output values, the confidence score for m1 (74) is further augmented by the probability distribution for each value in the distribution.

An anomaly detection algorithm (49) is shown in FIG. 12 in accordance with an illustrative embodiment of the present invention. The algorithm (49) can be implemented, for example, via the main server (9). The system uses a previously discovered mapping relationship (e.g., map m1 (74)) that predicts the relationship between a given set of input data (e.g., age, sex, weight, symptom) (82), (83) and an expected output or distribution or outputs (e.g., potential types of diagnoses) to compare the expected result obtained from the given map (i.e., map m1 (74)) with the actual output as indicated at (84).

By way of an example, the system can examine the data about a given medical invoice, or a series of medical invoices, for a given subscriber and compare the actual claimed data (such as claimed expenses, treatment provided, tests performed) with what the expected data would be using formulae obtained from various regressions methods based on the combination of actual input data (such as patient age, symptoms, prior ailments, or season) to determine whether the actual data varies from the expected data. For each given variance, the system assigns a weight to the difference based on the confidence score of the formula used to derive the “expected data”. The system then adds the weighted variances to determine an overall variance score (81), (88), (89).

The system can specify the claims that have a high “variance score” on the user-interface to alert subscribers or other system users to take proper follow-up action, such as examining the claim in more detail or contacting the service provider for correction. More specifically, the system can identify data elements claimed on one or a series of medical invoices with variance scores that exceed a certain threshold. The system can then report the identified data points as “potential errors” for further evaluation, for example.

In another aspect, the system tracks a subscriber's health over a selected period of time, and using statistical analysis and projections based on data from other subscribers in the same age and health category, helps the subscriber make adjustments to his/her health, dental, or medical insurance, as well as section 125 plan, to obtain optimum coverage with least out of pocket expenses. Alternatively, the system can use statistical analysis and projections based on data to detect errors in billing or reimbursement, among other uses or applications.

Still referring to FIG. 12, the system runs multiple comparisons with multiple mapping relationships (using different mapping relationships previously discovered for different combinations of input and output data), and in each case, compares the expected output result with the actual output result (86) and (87). The following are examples of expressions for mapping relationships and are understood to be illustrative and non-limiting:

(1) Linear Map:

Expected Diagnosis=map m(age, sex, symptoms, weight),

with m being a linear function of input parameter

(2) Polynomial Map:

Expected Diagnosis=map m(age, sex, symptoms, weight),

with m being a polynomial function of input parameters

(3) Non-linear Map:

Expected Diagnosis=map m(age, sex, symptoms, weight),

with m being a non-linear function of input parameters

(4) Semi-Parametric Map:

Expected Diagnosis=map m(age, sex, symptoms, weight),

with m being a composite function of a number of parametric functions of input parameters. For example:

Expected Diagnosis=map m(age, sex, symptoms, weight)=mw(age)+mx(sex)+my(symptom)+mz(weight)

In this case mw, mx, my, and mx are each a different function, and are all joined through the addition operator to form ‘m’

(5) Non-Parametric (e.g., regionally semi-parametric or parametric):

Expected Diagnosis=map m(age, sex, symptoms, weight),

with m being a non-parametric function which is described through regional functions, each of which may be semi-parametric or parametric

(6) Statistical Distribution:

Expected Diagnosis=map m(age, sex, symptoms, weight),

with m describing a range of possible values for the expected diagnosis each with a potential likelihood, for example:

Expected Diagnosis from (age:12, sex: male, symptoms: headache & 100 fever, weight:75)=[Flu, 10%], [Cold, 30%], [Migraine, 5%], [Tick Fever, 5%], [Strep, 10%], [Ear Infection, 20%]

Still referring to FIG. 12, depending on the type of mapping relationship, the expected output value may be a single value or may be a distribution of multiple potential values. If the expected output is a single value (85) that differs from the actual output (89), the maximum-variance value is assigned as the variance score, and the anomaly detection algorithm moves on to another mapping relationship (82). If the expected output is a range of multiple values (87), and the expected output is not in the possible range, the maximum-variance value is assigned as the variance score (88), and the anomaly detection algorithm moves on to another mapping relationship (82). However, if the actual value is an expected value (88), the variance is calculated using the following formula:

Variance Score=Variance Score+(1−Probability of observation of the actual output)*maximum−variance

After calculation of variance score for the given map, the algorithm (49) can proceed to other mapping relationships. At the end of the process, the system adds all weighted variance scores to arrive at an aggregate variance score, and compares that aggregate variance score to a pre-determined threshold to decide whether an anomaly is probable or not.

In accordance with an illustrative embodiment of the present system, shown in FIG. 13, as part of the first step (60) in anomaly detection algorithm (49) shown in FIG. 8, the system may run through multiple inter-related records with the same equal value in one or more fields (e.g., the same subscriber, the same service provider, the same zip-code, or the same employer) (91) and, in each case, calculate the variance between the statistical distribution of various other data-points in the given data-set (92) (e.g., the types diagnosis and frequencies of each type of diagnosis made by one given dermatologist) against the same distribution for a comparison population(s) (93). In this example, the comparison population can be types of diagnosis and frequencies of each type of diagnosis made by a statistically relevant sample of dermatologists. The variance thus calculated is then compared with a pre-determined threshold to decide whether an anomaly is probable (95) or not (96).

In accordance with another embodiment of the present invention, a method and system of automated data analysis uses graph topography analysis techniques in a connections-mapping process which creates topographic map of relationships between various data fields in the system to expose various hidden graphs in the data. The word “map” in this context does not refer to a “mapping function” but rather a map depicting a graph of nodes and edges (or lines).

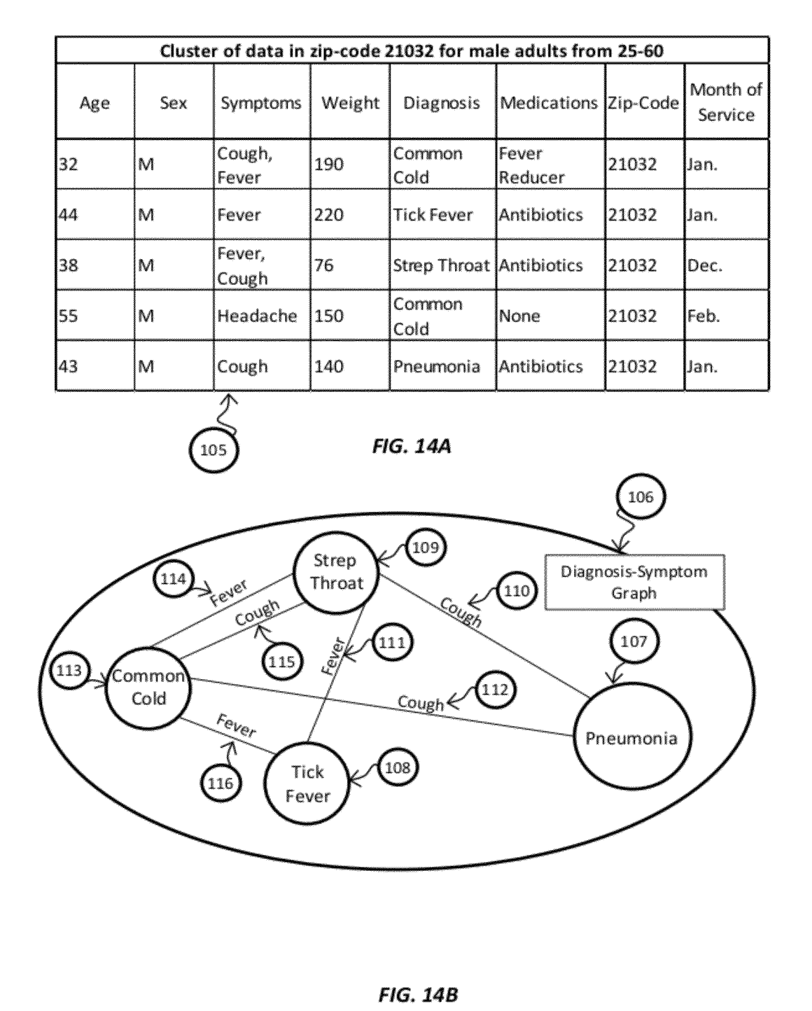

The connections-mapping process is an iterative process in which data is first clustered along one or more shared criterion such as geographical proximity, subscriber age group or gender, service provider's expertise. An illustrative example (105) is shown in FIG. 14A. The shared data in each cluster is set aside, and the remaining data fields are taken through the iterative process of graph analysis. In this process, one data field is treated as a node (or vertex), and another data field is treated as a line (or edge). For example, each distinct diagnosis is considered as a node, and each distinct symptom is considered as a line (edge). The topographic map that results from this view connects “strep throat” (i.e., a type of diagnosis) with “common cold” (e.g., another diagnosis) through their shared symptoms (lines) which may be “fever” and “cough” as indicated at (106) in FIG. 14B. In this example of a topographic map, “strep throat” and “common cold” have one degree of separation, which means that one can traverse from “strep throat” to “common cold” in one hop, and are connected with two lines (e.g., symptoms in this illustrative scenario).

Once the system (e.g., server (9)) creates one topographic map for the given cluster against the reference criterion, it will analyze the graph connections and quantify various aspects of the graph using common metrics in graph theory such as order (i.e., the number of nodes or vertices), size (i.e., the number of lines or edges), diameter (i.e., the longest of the shortest path lengths between pairs of nodes or vertices), girth (i.e., the length of the shortest cycle contained in the graph), clustering coefficient, vertex connectivity (i.e., the smallest number of nodes or vertices whose removal disconnects the graph), edge connectivity (i.e., the smallest number of lines or edges whose removal disconnects the graph), independence number (i.e., the largest size of an independent set of nodes or vertices), clique number (i.e., the largest order of a complete sub-graph), algebraic connectivity, vertex chromatic number (i.e., the minimum number of colors needed to color all nodes or vertices so that adjacent vertices have a different color), edge chromatic number (i.e., the minimum number of colors needed to color all lines or edges so that adjacent edges have a different color), vertex covering number (i.e., the minimal number of nodes or vertices needed to cover all edges), edge covering number (i.e., the minimal number of lines or edges needed to cover all vertices), isoperimetric number, arboricity, graph genus, pagenumber, Hosoya index, Wiener index, Colin de Verdiere graph invariant, boxicity, strength, degree sequence, graph spectrum, characteristic polynomial of the adjacency matrix, chromatic polynomial (e.g., the number of k-colorings viewed as a function of k), and Tutte polynomial (e.g., a bivariate function that encodes much of the graph's connectivity), among other metrics.

The system will also analyze the graph for the modularity of its structure. Modularity in graph theory is used to measure of the strength of division of a network into modules (also called groups, clusters or communities). In this analysis, the system can identify “communities.” In graph theory, community structure refers to the occurrence of groups of nodes in a network that are more densely connected internally than with the rest of the network.

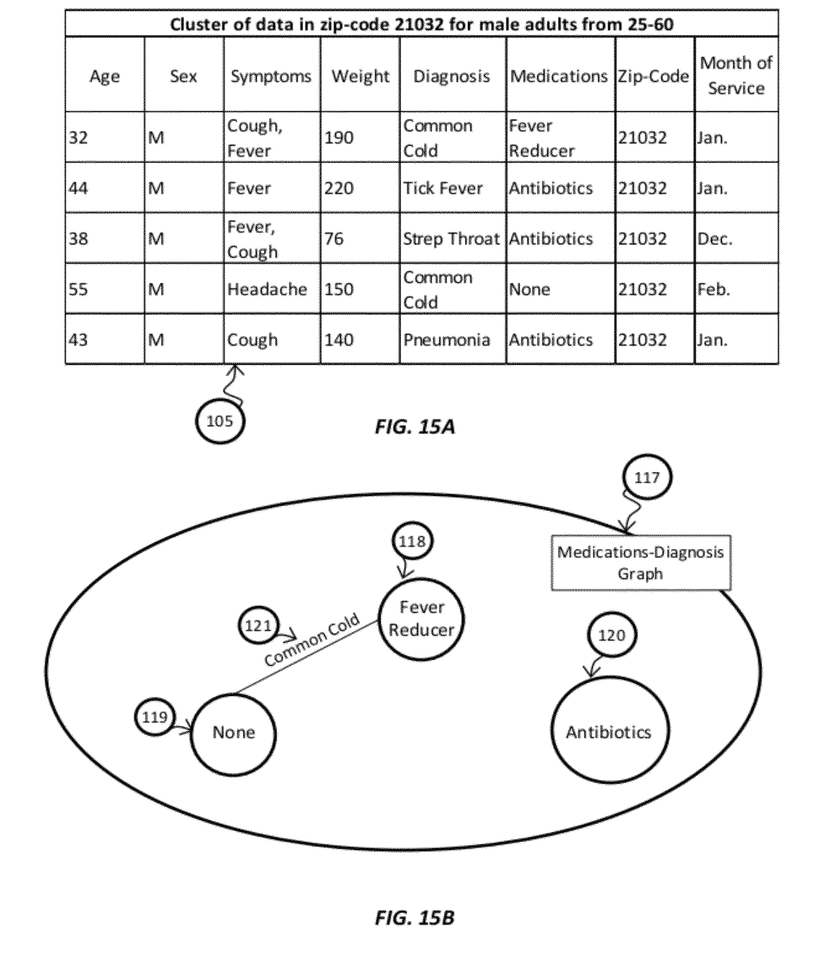

Once the above analysis is complete, the system saves the graph data for the given cluster, and repeats the process for new sets of nodes (vertices) and lines (edges) in the cluster's data-set. For example, referring to FIGS. 14A, 14B, 15A and 15B as an illustrative depiction, if cluster X (105) was identified based on parameters (age-group:25-60, sex: male, zip-code: 21032) as shown in FIGS. 14A and 15A, then the first graph X-1 (106) shown in FIG. 14B for this cluster X (105) may have “Diagnosis” as node (vertex) and “Symptom” as line (edge), while a subsequent graph X-2 (117) shown in FIG. 15B as an illustrative depiction, may have “Medication” as node and “Diagnosis” as line.

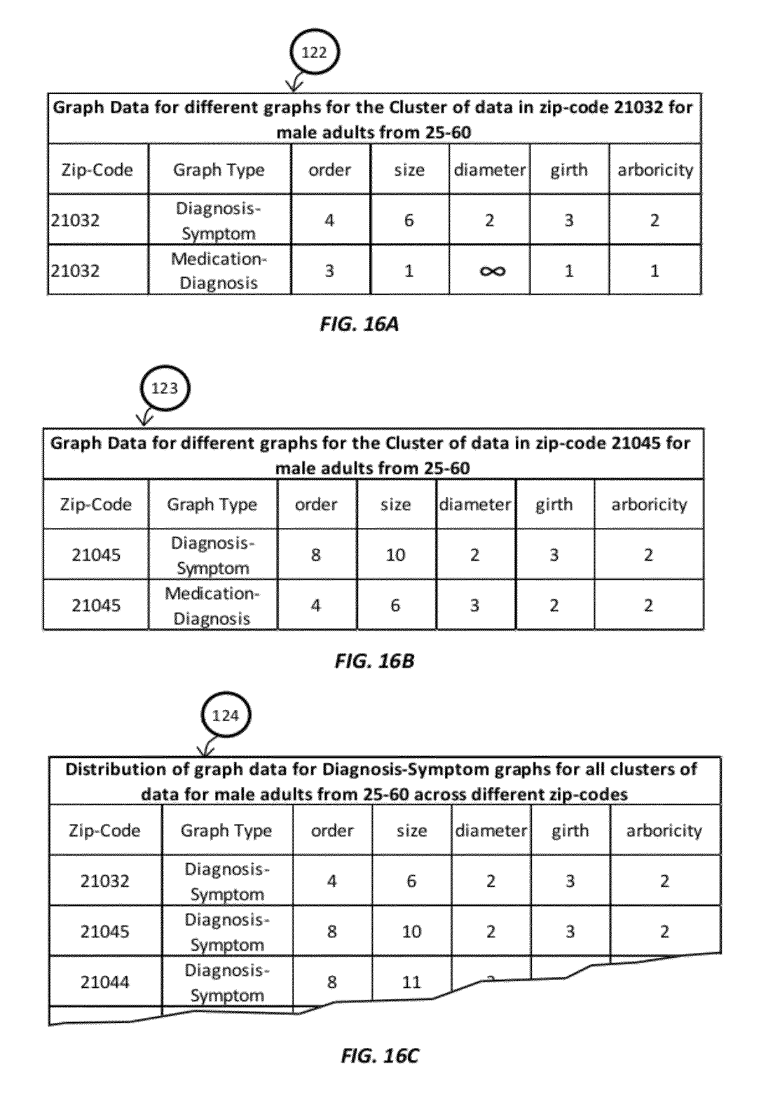

At the end of each cycle, the system will have multiple graphs (and associated graph quantitative data) for each cluster. Illustrative table (122) shown in FIG. 16A summarizes the quantitative data for two different graphs (106) and (117), and illustrative table (123) shown in FIG. 16B summarizes the quantitative data for two other graphs pertaining to zip-code 21045 (individual graph data not shown).

In the final stage, the system analyzes the previously identified clusters, and determines which clusters can be grouped together in super-clusters based on similar values in a sub-set of their “reference criterion.” For example clusters A, B, and C all have parameters “similar age-group, same sex, same zip-code” as their reference criterion. If the values for age-group and sex in clusters A and C are the same (e.g. age-group:25-60, sex:male), then the system groups these two clusters together in a super-cluster, with all cluster members having similar age-group, similar sex, but each pertaining to a different zip-code. An illustrative super-cluster (124) is shown in FIG. 16C where graph data pertaining to different clusters for male adults aging 25-60 years is shown in a table format (124). Once all members of a super-cluster are identified, the system will go through all similar graphs in the given super-cluster (e.g., similar graphs being those that have similar fields for node and lines such as all of them having “Diagnosis” as node and “Symptom” as line) and calculates the expected graph profile using the quantitative data for all the similar graphs, as well as the statistical distribution of various graph data. The calculation of “expected graph profile” may use various statistical techniques such as averaging, linear regression, polynomial regression, neural networking, or other techniques well known to experts in the art of statistical machine learning. At the conclusion of this process, the system will identify those graphs whose profile (set of quantitative data) vary from the expected profile, and also identify the extent of the variance against a set of tier-thresholds such as “no variance”, “low variance—anomaly suspected”, “medium variance—anomaly probable”, and “high variance—anomaly expected”. This data is then communicated to system users (subscribers or other users) for further evaluation.

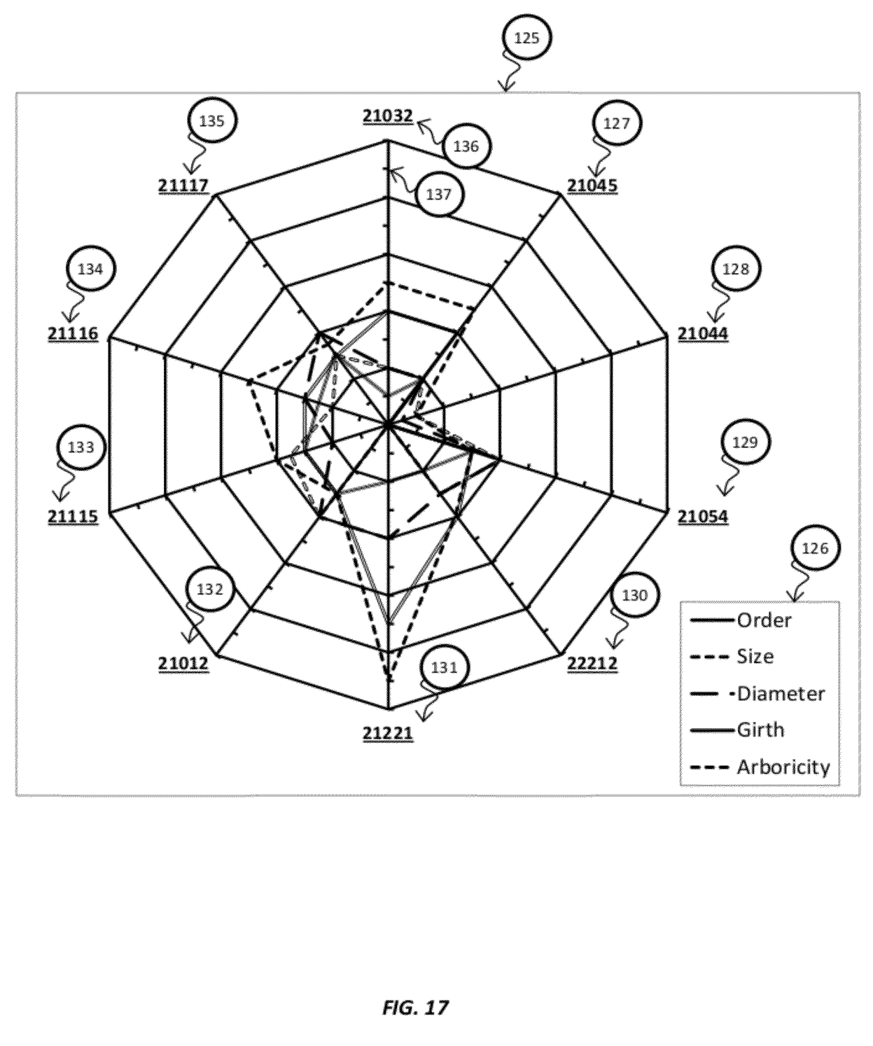

An illustrative view of the visual representation of the quantitative data for multiple graphs, all of the same graph type and all belonging to similar clusters in a given super-cluster, is shown in FIG. 17. In this illustrative representation, five sample metrics (126) for a given type of graph are shown. The graphs belong to clusters (which are in a given super-cluster) for zip-codes 21032 (136), 21045 (127), 21044 (128), 21054 (129), 22212 (130), 21221 (131). 21012 (132), 21115 (133), 21116 (134), and 21117 (135). As may be observed in the illustrative diagram, the metrics for graphs for zip-codes 21044 (128) and 21221 (131) diverge from the metrics for graphs for the rest of the zip-codes (21044 graph metrics collapse in while 21221 graph metrics expand out). The system evaluates such diversions from expected values to determine potential anomalies. In another aspect of the present invention, the system uses standard statistical regression and machine learning analysis to discover various mapping relationships between expected output values (dependent parameter) and input values (independent parameters), samples of which relationships are described above.

It is to be understood that the same level and type of statistical analysis described in paragraphs 80 to 104 is performed on hidden graphs exposed and quantified in paragraphs 105 to 108.

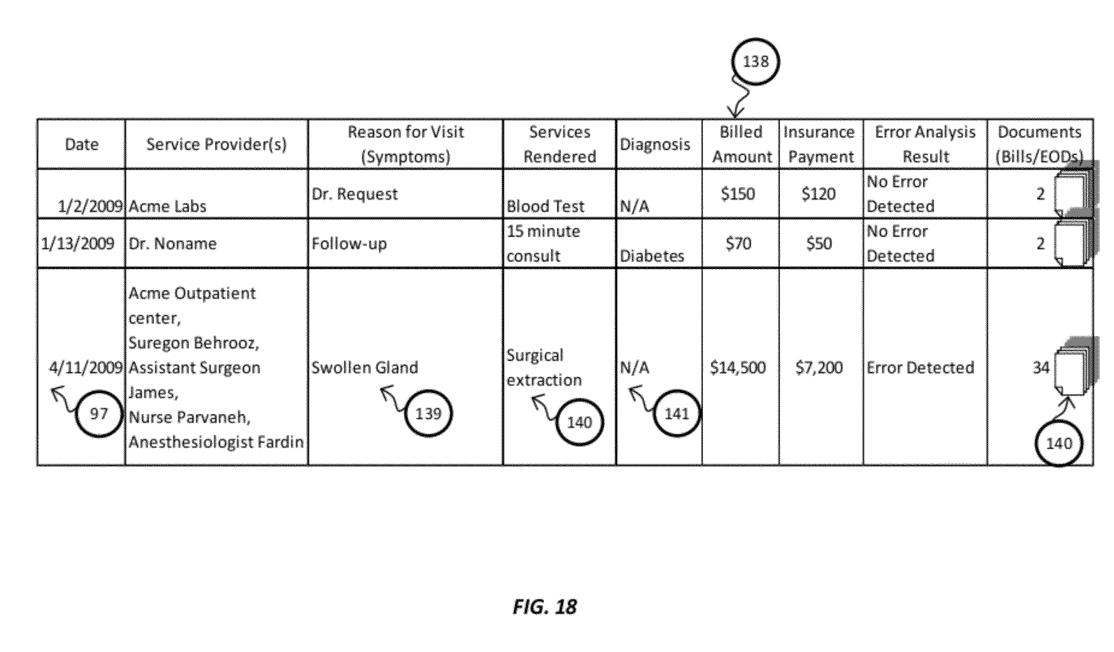

In accordance with an illustrative embodiment of the present invention, shown in FIG. 18, the system presents users and subscribers with an online interface that provides information about their health records as well as insurance and billing history. An illustrative view of such information is shown as a table (138) containing multiple rows, with each row showing a specific service encounter, with details such as Reason for Visit (Symptoms), Services Rendered, Diagnosis, and Billed Amount for each service encounter. The system may also provide the results of error analysis for each service encounter's billing data, and show the result in different color codes (green for “No Error”, yellow for “Error Suspected”, and red for “Error Detected”). The system will also allow the user to change any of the data (such as, referring to a specific encounter (97), “Reason for Visit” (139), “Services Rendered” (140), or “Diagnosis” (140)) by simply typing over the data shown. Referring still to FIG. 6, specific encounter (97), the system may also allow the user to click on the documents icon for a given encounter and view the list and contents of various documents related to an encounter, such as physician invoices, insurance explanation of benefits, lab results, and doctor's reports.

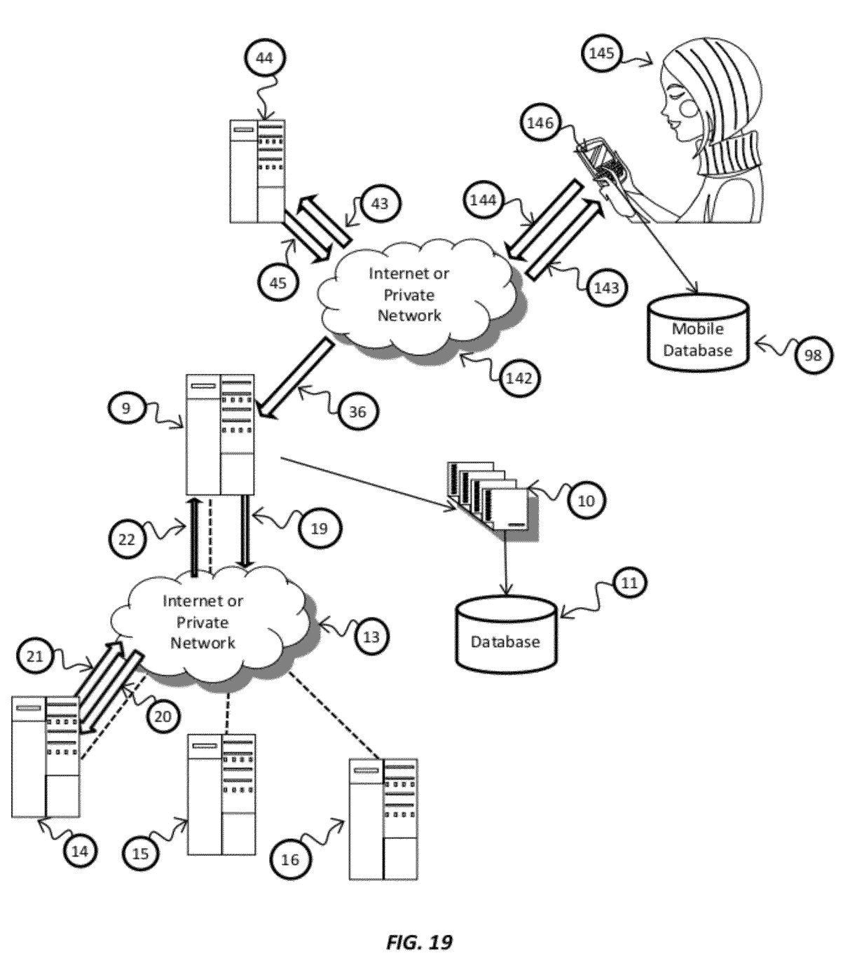

In accordance with an illustrative embodiment of the invention, shown in FIG. 19, the system allows subscribers or users (145), to use a computing device (146) (e.g. a mobile personal digital assistant), to generate requests about a subscriber's health service information via electronic messaging (143) through the Internet or private network (42) sent to message parsing server (44), and from there, the processed message (45) is forwarded to the main server (9) through the Internet or private network (42). Still referring to FIG. 19, the subscriber may access information such as health insurance co-pay for specific procedures, or update health or service-encounter information (such as doctor's recommendations) using an application residing on the computing device (146) and interacting with the main server (9). The said application may also have access to a mobile database (98) residing on the computing device (146) which maintains information pertaining to this subscriber, and is synchronized with the main database (11) through special electronic messages sent (144) and received (143) through the Internet or private network (42) to the main server (9), and from there to the main database (11).

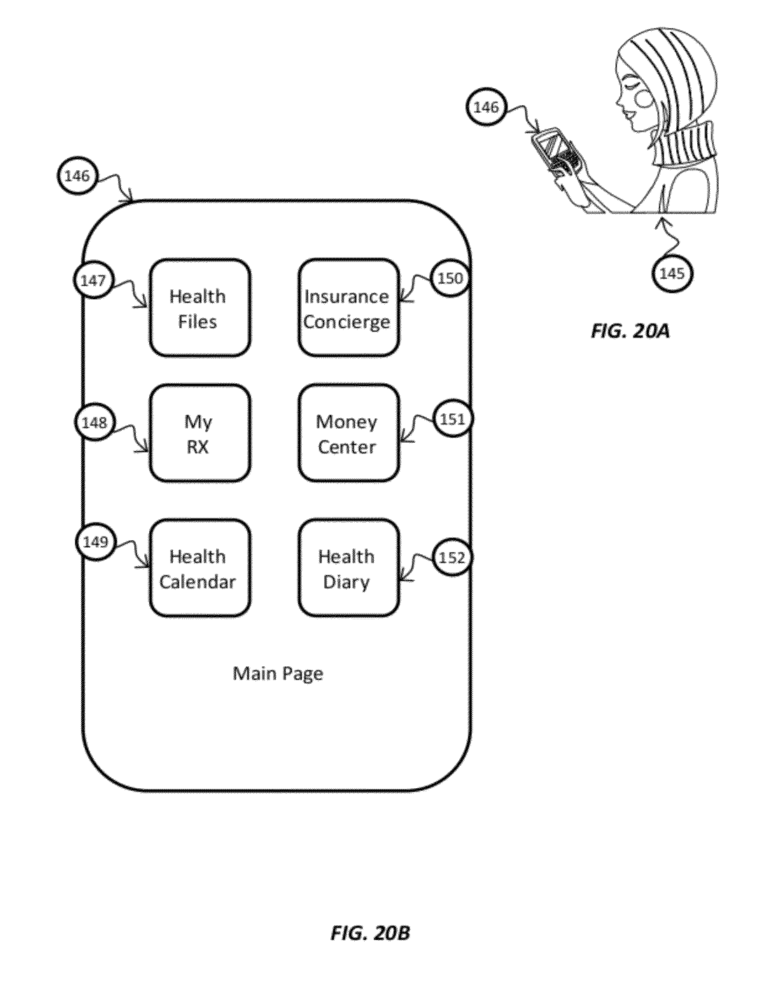

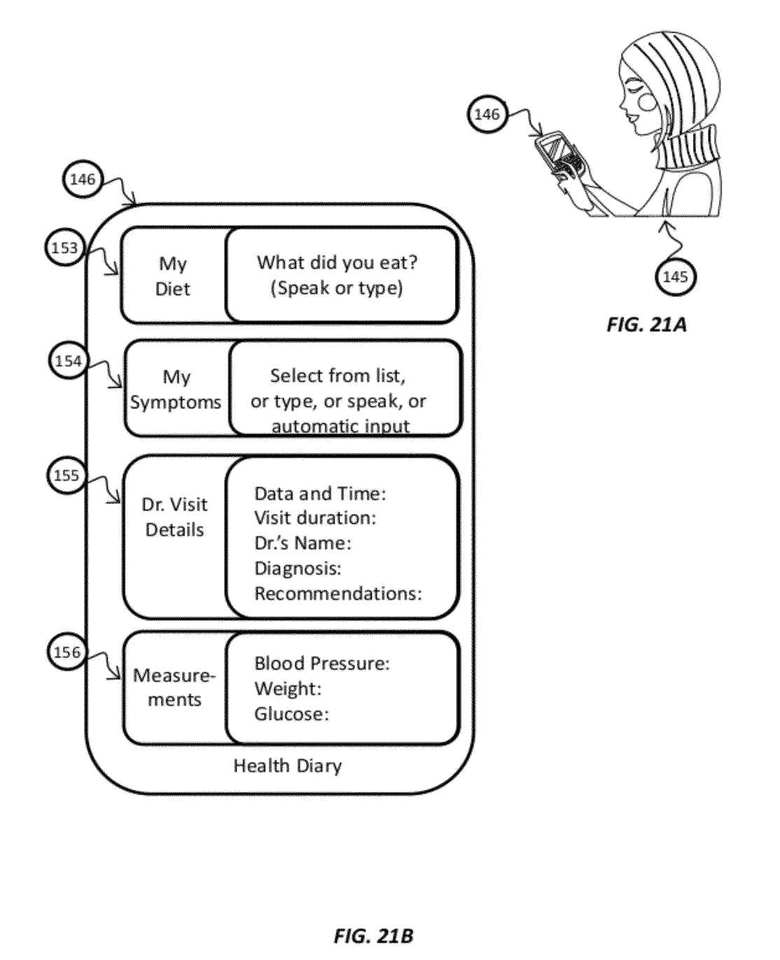

In accordance with an illustrative embodiment of the invention, shown in FIGS. 20A and 20B, the user or subscriber (145) may use an application residing on the users' computing device (146) which provides an interface for the user to access various services such as “Health Files” (147), e.g., to retrieve and update subscriber's various health related records such as service encounter history, lab test results, doctor's reports, insurance explanation of benefit and medical billing documents, “Insurance Concierge” (150), e.g. to retrieve frequently-asked-questions about a subscriber's level of coverage and co-payments, “My Rx” (148), e.g. to retrieve and update a subscriber's prescriptions, active and archived, “Money Center” (151), e.g. to retrieve and update a subscriber's financial questions regarding various health issues such as co-payments or bills outstanding, “Health Calendar” (149), e.g. to retrieve and update a subscriber's health related records using a calendar schema, and “Health Diary” (152), e.g. to retrieve and update a subscriber's health related information such as daily diet, medications prescribed and taken, measurements, and symptoms. Still referring to FIG. 20, the said services may be delivered using multiple other “follow-on” pages and pop-up dialogs where the user retrieves information through text, images, spoken audio, or other biological signals (e.g. direct or indirect nerve stimulation), and updates information through tactile, spoken, hand, face, or body gesture, or other biological interface depending on the capabilities of the mobile computing device (146). One illustrative example of a “follow-on” page is shown in FIG. 21.

Still referring to FIG. 20, and also referring to FIG. 19, the application residing on the computing device (146) may access the main server (9) or the local mobile database (98) to render various services for the user or subscriber (145).

In another aspect of the invention, shown in FIGS. 21A and 21B, the user or subscriber (145) may access “follow-on” pages of the said mobile application to access specific services. An example of such “follow-on” page, shown for illustrative purposes in FIG. 21, may be the “follow-on” page for “Health Diary”, where the user may retrieve and update different information. Still referring to FIG. 21, the subscriber may:
retrieve or update information such as daily diet (153) by speaking or typing,
retrieve or update their symptoms (154) through tactile interface (e.g. typing or selecting from a list), voice interface, or through a machine-to-machine interface—wired or wireless—to devices attached to or inside the patient
retrieve or update the details of a doctor's visit (155) such as Date, Time, Duration, Doctor's name, Diagnosis, Recommendation or other relevant information by typing, speaking, or through direct interface with electronic systems at a service provider's office
retrieve or update medical and health measurements (156) such as blood pressure, temperature, Glucose, or other body functions by typing, speaking, or a machine-to-machine interface—wired or wireless—to devices attached to or inside the patient

As stated above, the foregoing description of automated data analysis has been in connection with medical services encounter data in accordance with illustrative embodiments of the present invention. It is to be understood, however, that the automated analysis described herein can be applied to other types of data such as financial data and any other body of data having two or more types of data elements or fields. The automated data analysis in accordance with illustrative embodiments of the present invention is advantageous in automating the determination of interrelationships between various data elements in a body of data for various purposes (e.g., anomaly detection, fraud detection, cost management, management of services or other resources represented by the data fields, among other uses).

Illustrative embodiments of the present invention have been described with reference to algorithms implemented via a main server (9) or other processing device. It is to be understood, however, that the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains.

While the invention herein disclosed has been described by means of specific embodiments and applications thereof, numerous modifications and variations can be made thereto by those skilled in the art without departing from the scope of the invention.

What is claimed is:

1. A set of instructions stored on a non-transitory computer readable media for performing a method of automated data analysis comprising the steps of:
(a) accessing data stored in a memory device, the data comprising a plurality of records, each of the records having different data fields, each of the data fields representing a respective type of information;
(b) selecting at least two of the data fields to each be a reference criterion;
(c) dividing the data into clusters of data sharing at least one of the reference criterion;
(d) iteratively analyzing each cluster of data by
(1) using at least a first connections mapping process wherein at least one of the data fields is assigned to represent a node and at least another one of the data fields is assigned to represent a line to generate a first topographic map of the cluster of data, and
(2) repeating step (d)(1) for the same cluster of data at least once by assigning a different one of the data fields to represent a node or a line to generate another topographic map of the cluster of data;
(e) analyzing multiple graphs for each of the clusters of data using selected metrics to identify quantitative profiles for each graph, the graphs comprising the topographic maps generated using step (d);
(f) determining which clusters are assigned a super-cluster based on similarities between at least one of the reference criterion;
(g) analyzing the quantitative profiles of the graphs for each of the clusters in the super-cluster to identify similar graphs; and
(h) calculating an expected graph profile for the similar graphs using data from the quantitative profiles of each of the similar graphs and statistical processing.

2. A method as claimed in claim 1, further comprising determining the variance between at least one of the multiple graphs for each of the clusters of data and the expected graph profile.

3. A method as claimed in claim 1, wherein the selected metrics are graph theory metrics comprising order, size, diameter, girth, clustering coefficient, vertex connectivity, edge connectivity, independence number, clique number, algebraic connectivity, vertex chromatic number, edge chromatic number, vertex covering number, edge covering number, isoperimetric number, arboricity, graph genus, page number, Hosoya index, Wiener index, Colin de Verdière graph invariant, boxicity, strength, degree sequence, graph spectrum, characteristic polynomial of the adjacency matrix, chromatic polynomial, Tutte polynomial, and modularity, and community structure.

4. A method as claimed in claim 1, wherein at least one of analyzing in step (e) and statistical processing in step (h) comprises at least one of statistical regression and a machine learning algorithm.

5. A method as claimed in claim 1, wherein the data stored in the memory device comprises medical service encounter data for respective ones of a plurality of subscribers, the medical service encounter data comprising the plurality of data fields relating to symptoms, medical service, and subscriber-health related data, and medical service provider data, and further comprising determining the variance between at least one of the multiple graphs for each of the clusters of data and the expected graph profile to identify anomalies in the medical service encounter data.

6. A method as claimed in claim 5, wherein at least one of analyzing in step (e) and statistical processing in step (h) comprises at least one of statistical projection and a machine learning algorithm to forecast at least one of a subscriber's health changes and medical billing changes.

7. A set of instructions stored on a non-transitory computer readable media for performing a method of automated data analysis comprising the steps of:
(a) accessing data stored in a memory device, the data comprising a plurality of records, each of the records having different data fields, each of the data fields representing a respective type of information;
(b) processing the data to identify hidden networks therein by dividing the data into clusters of data and analyzing each cluster of data using an iterative connections-mapping process to identify the hidden networks wherein at least one of the data fields is assigned to represent a node and at least another one of the data fields is assigned to represent a line; and
(c) analyzing the hidden networks using at least one of machine learning and pattern recognition.
